(19) United States
(12) Patent Application Publication
(10) Pub. No.: US 2004/0049679 A1
(43) Pub. Date: Mar. 11, 2004

(54) Authenticating method and device

(76) Inventor: Claude Meggle, Paris (FR)

Correspondence Address: MCCRACKEN & FRANK LLP, 200 W. ADAMS STREET, SUITE 2150, CHICAGO, IL, 60606, US

(21) Appl. No.: 10/432,073

(22) PCT Filed: Nov. 14, 2001
(86) PCT No.: PCT/FR01/03569

(30) Foreign Application Priority Data
Nov. 21, 2000 (FR) FR00/15007

(51) Int. Cl. H04L 9/00

(52) U.S. Cl. 713/172; 705/67

(57) ABSTRACT

The invention concerns an authenticating device comprising an apparatus (1) for carrying out transactions. The apparatus (1) comprises a housing protected against breaches. In the housing are integrated an interface circuit (10) for receiving an identification support including an identification logic circuit, man-machine interface means (3, 4) for displaying transaction data and for receiving from the user identification data transmitted to the logic circuit via the interface circuit (10) and signature commands related to the transaction data displayed, a protected circuit (6) for delivering a first signature of transaction data in response to signature commands when the identification has been completed, said signature being obtained by encrypting part at least of the transaction data using a non-erasable private signature key stored in the protected circuit.

The field of the invention is that of the authentication of electronic documents by means of a digital signature.

Here, the expression electronic document is understood to mean a series of numbers in binary form which codes computer data.

The embodying of documents in electronic form exhibits numerous advantages, ease of storage, of duplication, of modification, of transmission. However, for certain uses, these advantages turn into drawbacks.

For example within the framework of electronic commerce by means of open systems, the transmitting of data relating to an account reference and to an amount to be debited is made easier by open networks such as the Internet. These data are easily interpretable in a dialog between sender open system and receiver open system. However, if no particular care is taken, duplication, modification, transmission of these data are as easy for a system intercepting the messages as for the authentic sender and receiver systems.

In a known manner, cryptography makes it possible to encipher the content of a document so that only the authentic receiver system can interpret the content of the document.

There is a distinction made between symmetric cryptography, where one and the same secret key serves to encipher and to decipher the document, and asymmetric cryptography, where a pair of distinct keys, one private the other public, is used.

Symmetric cryptography is adapted for dialog within a single sender receiver pair with reciprocal trust since the sender and the receiver secretly share the same key.

Asymmetric cryptography is better adapted for establishing a dialog with numerous potential participants. Such is the case in electronic commerce where any buyer must be able to get in touch privately with any seller and any financial establishment.

When the private key is in the custody of the receiver system, any sender system can encipher a document by means of the public key and transmit it to the receiver system. Only the receiver system can decipher the document by means of the private key. This ensures the confidentiality of the document transmitted.

When the private key is in the custody of the sender system, the latter alone is able to encipher the document. Any receiver system can decipher the document, doing so with the assurance that the sender system which transmitted the document, is the one which possesses the private key.

The implementation of asymmetric cryptography turns out to be slower than that of symmetric cryptography, given that the algorithms involved require more calculations. To satisfy processing speed objectives it is appropriate to apply the encipherment by means of a private key, to documents of small size. This mode of encipherment is well adapted for authenticating a sender and for authenticating the veracity of a document.

For example, to authenticate a sender, the receiver dispatches a document consisting of a random sequence to the sender. The sender enciphers the document received by means of his private key and transmits the enciphered document to the receiver. The receiver deciphers the enciphered document by means of the public key that he knows to be that of the sender. By comparing the result with the random sequence initially transmitted, the receiver is assured that the sender is indeed the expected sender if the result is identical to the random sequence initially transmitted since the expected sender is alone able to encipher the document by means of his private key.

To authenticate an original document, the sender applies a specified function to the document so as to obtain a document which is generally of reduced size. The specified function may in particular be a one-way hash function. The sender enciphers the reduced-size document by means of his private key and transmits the reduced-size document thus enciphered to the receiver, accompanied by the original document as plaintext. The receiver applies the one-way hash function to the original document received and deciphers the enciphered reduced-size document received, by means of the public key that he knows to be that of the sender. If the result of the hash function is identical to that of the decipherment, the receiver is assured that the document received as plaintext is identical to the sender's original document.

A reduced-size document enciphered by means of the private key of the sender such as that described in the paragraph above is also referred to as the electronic signature of the original document. The private key is then often referred to as the signature key so as to distinguish it from a private deciphering key. A choice of different private keys for decipherment and for signature makes it possible to avoid certain known attacks.

Within the framework of electronic commerce, if the original document contains an amount to be debited in order to enable a purchase, an intermediate system cannot modify the amount to be debited since the electronic signature would no longer correspond to the original document. Any modification of the original document is impossible by an intermediate system which does not know the sender's private key and therefore has little chance of being able to recreate a new valid electronic signature.

Duplication of the original document and of its signature could allow the intermediate system to retransmit the original document with a valid signature to the receiver so as for example to debit the sender's account several times. Diverse means make it possible to avoid this drawback, such as for example the inserting of a date into the original document.

The attraction of signing by electronic signature which emerges from the above explanations is not limited to electronic commerce. The fields of application are numerous and varied. The electronic signature can serve for example to authenticate an agreement given with regard to a contract, medical case references, etc.

However, numerous problems still arise with regard to increasing the confidence accorded to an electronic signature, both with regard to a person sending and with regard to a person receiving.

With regard to a sending person using an open system such as a personal computer, an incursion by a malicious person into the computer may place components therein which hijack the actions of the person sending on the personal computer. A physical incursion is possible in the absence of the person sending, a logical incursion by the network is possible even in the presence of the person sending, the ability of computer viruses to modify the behavior of programs is for example well known. The goals of such incursions are numerous, to access the value of the private key, to replace the value of the private key with a known value, to replace the original document with another document before the moment at which the original document is destined to be hashed or enciphered.

The sending person's legitimate grounds for unease have a knock-on effect on the receiving person. Even if the receiving person receives a valid signature, the sending person may wish to repudiate this signature, alleging that it was made without his knowledge.

Secret custody of the private key by the sending person himself is of debatable reliability. The sending person may wish to argue that the secret key value was taken from him at a time of distraction or more simply at the time of its communication to the cryptographic system.

To alleviate the drawbacks which emerge from the current state of the art, the subject of the invention is an apparatus for performing transactions comprising a housing having protection against break-ins, in which are integrated:

an interface circuit for receiving an identification support comprising an identification logic circuit;

man/machine interface means for presenting transactional data to a user and for gathering from the user identification data transmitted to the logic circuit of the support via the interface circuit as well as signature commands relating to the transactional data presented;

a protected circuit for delivering a first signature of the transactional data presented in response to the signature commands when the identification has been performed, said signature being obtained by enciphering a part at least of the transactional data by means of a private signature key stored in a nonerasable manner in said protected circuit.

Another subject of the invention is a method of manufacturing an apparatus for performing transactions. The manufacturing method comprises a burn step during which a pair of dual cryptographic keys is secretly generated, consisting of a public key and of a private key of the apparatus, the private key being burned immediately into a protected circuit in such a way as to not be able to leave any trace outside said protected circuit, a mounting step during which a man/machine interface is mounted on a housing, the protected circuit and an interface circuit are mounted in said housing and during which said housing is closed in such a way as to no longer be able to be opened or entered without leaving a visible trace of break-in.

Another subject of the invention is a method for performing transactions by means of an apparatus consisting of a housing which leaves a visible trace of any attempted break-in, said housing comprising man/machine interface means and an interface circuit for interfacing with a physical identification object. The method comprises a presentation step during which at least one transactional data item is communicated to the apparatus which displays it on the man/machine interface means, an identification step during which an identification support comprising an identification logic circuit is placed in contact with the interface circuit and first identification data are gathered from the user by the man/machine interface means, then transmitted to the identification logic circuit which delivers an identification signal if it recognizes said identification data, a signature step during which, a signature command gathered on the man/machine interface means is transmitted in the housing to a protected circuit which, if said identification data are recognized by the identification circuit, signs a part at least of the transactional data by means of a private signature key stored in a nonerasable manner in said protected circuit.

Other details and advantages will emerge from the description of a mode of implementation of the invention, such as it follows with reference to the figures where:

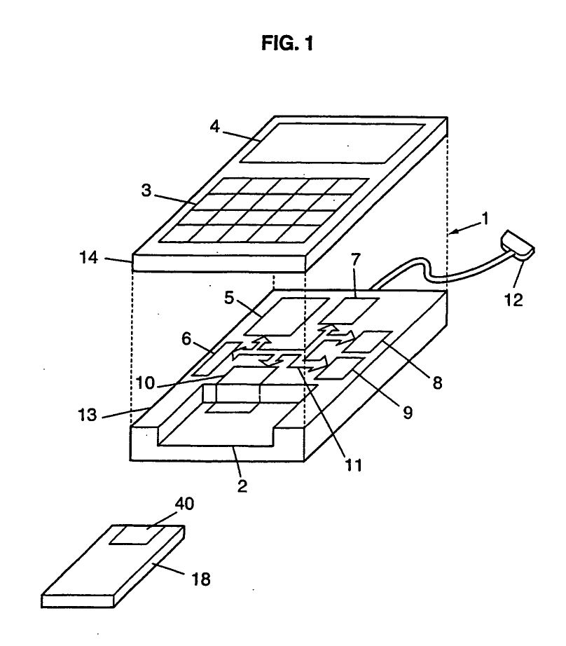

FIG. 1 depicts an apparatus in accordance with the invention;

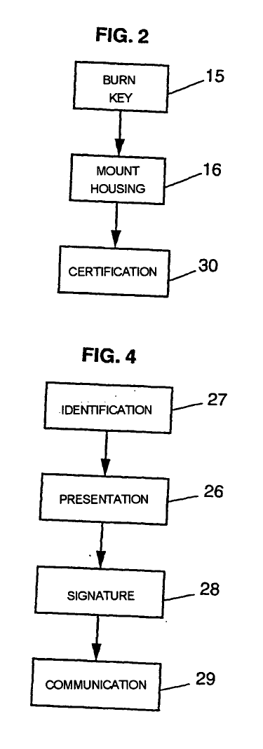

FIG. 2 depicts a method of manufacture in accordance with the invention;

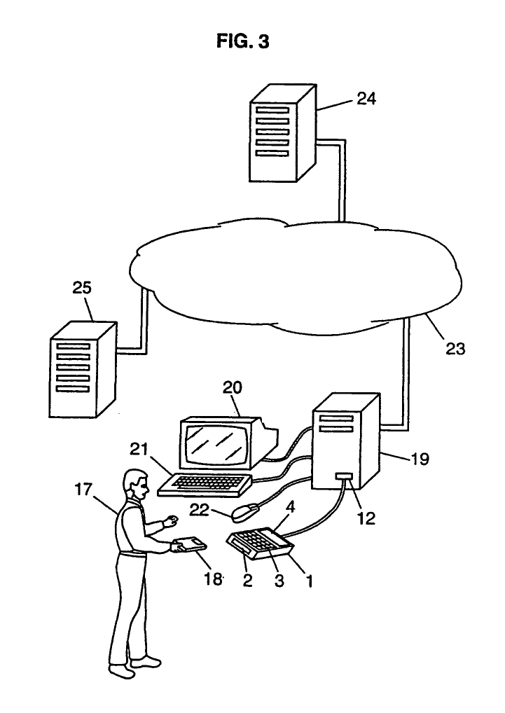

FIG. 3 depicts a possible environment for implementing the invention;

FIG. 4 depicts a method of use in accordance with the invention;

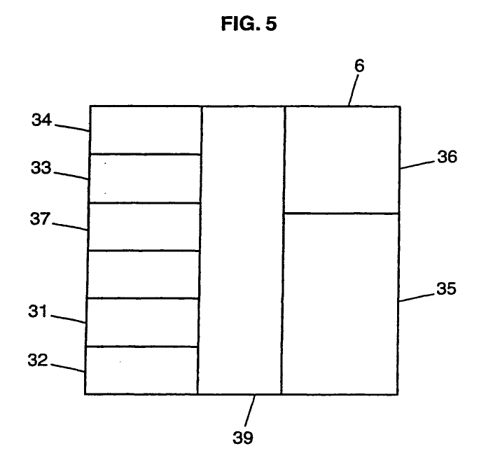

FIG. 5 depicts a protected circuit in accordance with the invention.

FIG. 1 depicts in an exploded diagrammatic view, an apparatus 1, the subject of the invention. This apparatus comprises a housing protected against break-ins. This protection can be of various levels:

the housing may exhibit visible traces, for example breakage of the shell, as soon as an attempted break-in occurs, (“tamper evident” level);

the housing may have a robust structure such as to resist attempted break-ins (“tamper resistant” level);

the housing can detect any attempted break-in to destroy or seriously damage components of the apparatus (“tamper responsive” level).

In the illustration, the housing is composed of two half housings 13 and 14. When manufacture is complete, the lower half-housing 13 and the upper half-housing 14 form a single housing such that any attempted break-in or any break-in leaves a visible trace, breakage or destruction.

The apparatus 1 comprises an opening 2 into which it is possible to insert an identification support 18. The identification support 18 has the function of a physical key for using the apparatus. The identification support 18 comprises a logic circuit 40 for identification in a known manner for example when the identification support is a chip card.

The identification support is inserted into the opening 2 until the identification circuit 40 is placed in contact with an interface circuit 10 linked to a system bus 11 internal to the apparatus 1.

A logic electric circuit 9 is linked to the system bus 11 so as to execute one or more sequences of dialog with the physical identification object. Advantageously, the dialog sequences form part of programs stored in a random access memory 5 linked to the system bus 11. The logic electric circuit 9 is then a microprocessor which executes program instructions by means of an operating system likewise stored in the random access memory 5.

An operator interface on the housing of the apparatus 1 comprises a keypad 3 and a screen 4. The keypad 3 and the screen 4 are fixedly linked in the apparatus 1, to an input/output circuit 8. The input/output circuit 8 linked to the system bus 11 allows the logic circuit 9 to execute one or more sequences of dialog with the operator interface by means of the programs stored in the random access memory 5.

A communication circuit 7 linked inside the housing to the system bus 11 and outside the housing to a connector 12 allows the logic circuit 9 to execute one or more communication sequences by means of the programs stored in the random access memory 5. The connector 12 is designed to be linked to a computer, a cable network, a modem or an aerial network. Depending on the mode of link-up chosen, the connector 12 is a pin connector, an infrared transmitter receiver or an antenna.

The apparatus 1 also comprises a protected circuit 6. The circuit 6 is for example of integrated circuit type, protected by a robust envelope which resists attempted break-ins (“tamper resistant” level) or for which any attempted break-in damages the circuit 6 (“tamper responsive” level).

With reference to FIG. 5, the protected circuit 6 comprises a dialog part 18 and a memory part 36 with read only access. The dialog part 18 is designed to exchange information with the bus 11. The memory part 36 is of nonerasable type such as for example a ROM memory. The memory part 36 contains data which are written thereto during the manufacture of the apparatus 1.

In particular, the memory part 36 contains a private logical key SK-DEV. The protected circuit 6 also comprises an arithmetic and logic processing part 39 for executing at least one operating system, microprogrammed functions contained in a random access memory part 35 of the protected circuit 6. Among the microprogrammed functions may be distinguished functions for enciphering data by means of the SK-DEV private key and of known cryptography algorithms. Among the microprogrammed functions may also be distinguished ordering functions for activating the enciphering functions in response to commands received by the dialog part 31. The protected circuit 6 is produced in such a way that the value of the private logical key SK-DEV can never be transmitted outside the protected circuit 6.

Thus, when the protected circuit 6 receives on its dialog part 31, transactional data and commands for signing the transactional data, the ordering functions activate the functions for enciphering inside the protected circuit 6, in such a way as to encipher at least one part of the transactional data by means of the SK-DEV private key which remains confined within the protected circuit 6. The SK-DEV private key is then a signature key and the signature obtained is made available by the protected circuit 6 on its dialog part 31.

A possible variant embodiment of the protected circuit 6 consists in integrating therein a first input/output module 32 intended to be linked directly to the interface circuit 10, a second input/output module 34 intended to be linked directly to the screen 4, a third input/output module 33 intended to be linked directly to the keypad 3, a fourth input/output module 37 intended to be linked directly to the means of communication such as the connector 12. The modules 33 and 34 then replace the input output circuit 8 in the apparatus 1. The module 37 replaces the communication circuit 7.

With reference to FIG. 2, the method of manufacturing the apparatus 1 comprises a step 15 in which is created a pair of logic keys for enciphering by means of a generator of numbers according to procedures known in the field of cryptography, in such a way that this pair of keys makes it possible to implement a known public-key cryptosystem such as for example RSA. A first key constitutes the private key SK-DEV which is burnt into the memory part 36 of the protected circuit 6 right from the creation of the pair of keys, this being so that no copy of the value of the private key as SK-DEV remains anywhere other than in the protected circuit 6.

The operations of the number generator from the creation of the pair of keys up to the burning of the private key into the protected circuit 6 are concealed so that the manufacturer of the apparatus can never know the private key SK-DEV.

The second key of the pair constitutes a public key PK-DEV, this one not necessarily being preserved in the nonerasable memory part 36 but possibly elsewhere with a view to subsequent processing.

However, burning the public key PK-DEV into the nonerasable memory part 36 affords an additional advantage, that of ensuring that the public key will never be lost as long as the protected circuit 6 is not effaced. The preserving of the public key on another support, random access memory 5 of the apparatus, external database, visible inscription, is acceptable but requires, however, management adapted to safe preservation of the public key PK-DEV.

Another additional advantage is afforded by also burning into the nonerasable memory part 36 of the protected circuit 6, an identification number of the apparatus 1. Like an engraving on a manufacturer's plate, the identification number makes it possible to track the apparatus. The burning of the identification number into the nonerasable memory part 36 makes this data item available for performing computer processing. The identification number consists for example of a first series of characters which identifies the manufacturer of the apparatus and of a second series of characters which identifies the apparatus within the batch of those produced by the manufacturer.

In a step 16, the components 7 to 11 are mounted in the lower half-housing 13. The keypad 3 and the screen 4 are mounted on the housing and are hooked up to the input output circuit 8, the connector 12 is hooked up to the communication circuit 7 and the upper half-housing 14 is fixed onto the lower half-housing 13 so as to constitute a single housing which hermetically seals the components 5 to 11, and in such a way that the housing thus constituted can no longer be reopened without causing irreversible and clearly visible defacement thereof.

Various known procedures are possible for arranging for any opening, entry, attempted opening or entry, to leave a visible trace of break-in. The lower half-housing 13 and the upper half-housing 14 may be fitted with single-fasten clips which break on unfastening. Instead of two half-housings, the various elements of the apparatus 1 may be embedded in a homogeneous resin.

Both the method of manufacture and the impregnable structure of the apparatus 1 implies that the value of the private key SK-DEV is not known to anybody. The value of the key SK-DEV is unknown to the manufacturer since its creation by the random number generator and its burning into the protected circuit 6 are not accessible.

The value of the key SK-DEV is unknown to anybody holding the apparatus in his hands since the operating system of the apparatus 1 does not allow reading of the value of the private key SK-DEV. In particular, the value of the private key SK-DEV cannot be communicated to the input/output circuit 8 and therefore, can never appear on the screen 4. Thus, there is no risk of any user of the apparatus 1 disclosing, intentionally or unintentionally, the value of the private key SK-DEV.

The value of the private key SK-DEV of the apparatus, is unknown to anybody or to any system communicating with the apparatus, since this value cannot be copied either into the random access memory 5, or into the interface circuit 10, or into the communication circuit 7.

The only solution which remains to a malicious individual is that of opening the housing of the apparatus 1 for example to corrupt the operating system by replacing one or more of the components 5 to 11 or to attempt to interfere with the protected circuit 6. However, the construction of the housing implies that this opening necessarily leaves visible traces of break-in. Faced with these visible traces of break-in, the custodian of the apparatus is aware that any use is made at his own risk and that he is obliged to report this break-in in the same way as he is obliged to report a loss of the apparatus in order to put a complete stop on any future use. Moreover, even opening the housing does not afford a knowledge of the private key SK-DEV since the latter remains confined within the protected circuit 6.

The order in which steps 15 and 16 are represented in FIG. 2 is of no importance. Step 16 may precede step 15 if the protected circuit 6 generates the key pair itself when the latter is already mounted in the housing.

A certification step 30 allows the manufacturer to certify the origin of the apparatus (1). During step 30, the manufacturer formulates a character string comprising at least the public key PK-DEV of the apparatus or an identification number of the apparatus.

The character string is enciphered by means of a private key SK-FAB of the manufacturer, in such a way as to obtain a certification signature. The certification signature is stored in the apparatus. Step 30 can be implemented at the same time as step 15. Step 30 can also be implemented after manufacture, for example so as to recertify the apparatus 1 following an overhaul. The apparatus 1 then contains a program which verifies a match between the certification signature and certain data such as the public key PK-DEV of the apparatus or the apparatus identification number, which are stored in the protected circuit 6, when loading the certification signature into memory 5 or 35.

FIG. 3 shows a possible environment of use of the apparatus 1.

A sending individual 17 consults for example an on-line mail order catalogue by means of a personal computer 19 furnished with a screen 20, with a keyboard 21 and a mouse 22. The computer 20 is hooked up to an open network 23, for example the Internet, to which servers 24, 25 are also hooked up. The server 25 transmits pages of the on-line mail order catalogue over the network 23. The sending individual 17 selects on the screen 20 by means of the mouse 22 an article from a catalogue page, the price of which is displayed. The sending individual 17 thereafter triggers a transaction so as to order and pay for this article.

This transaction allows a seller agency who is the custodian of the server 25 to have itself paid by a financial agency who is the custodian of the server 24, so as to deliver the selected article to the sending individual 17.

The sending individual 17 wishes to be certain that the amount debited from his account on the server 24 is limited to the amount which corresponds to the purchase price of the selected article. It must therefore not be possible for the amount debited to be modified in the open computer system which comprises the personal computer 19, the open network 23, the server 24 and/or the server 25. Within the particular framework of a financial transaction, the sending individual wishes moreover to be safeguarded against multiple debiting of the amount to which he gives his agreement just once.

The server 25 must be sure that the amount of the transaction is unquestionably debited to his benefit by the server 24. In particular, it must not be possible for the transaction to be repudiated in an uncontrolled manner.

The server 24 must be sure that the transaction is truly triggered with the agreement of the sending individual 17.

To guarantee the confidence of the participants in the transaction, the transaction implements a method of authenticating the amount to be debited which irrefutably marks the agreement of the individual 17. In the example of FIG. 3, the amount to be debited forms part of the transactional data to be signed by means of the method now explained with reference to FIG. 4.

During a presentation step 26, the transactional data item to be signed is communicated to the apparatus 1 described previously. The apparatus 1 then displays the transactional data item to be signed, on the screen 4.

When in the example of FIG. 3, the individual 17 is holding the apparatus 1 in his hands, he has good reason to be confident of the amount displayed on the screen 4 since he can check that the housing has no visible trace of break-in and hence that this amount is indeed the one actually processed by the apparatus 1.

The sending individual 17 can for example when on the move, communicate the amount of the transaction to the apparatus 1 themselves by using the keypad 3. Communicating the amount of the transaction to the apparatus 1 through the computer system offers the advantage of greater simplicity when the apparatus 1 has a communication link with the personal computer 19 in FIG. 3, by means of the connector 12.

During an identification step 27, an identification support 18 is placed in contact with the interface circuit 10. A code is typed into the keypad 3 to identify the person performing the transaction.

In the example of FIG. 3, the physical identification object is typically a credit card that the individual 17 inserts into the opening 2 until contact is made with the interface circuit 10. The code typed in is typically his four-digit confidential code followed by enter. The individual 17 thus makes himself recognized by the apparatus 1.

The logic circuit 9 executes an instruction sequence stored in memory 5 so as to transmit the value of the code typed on the keypad 3 to the identification object 18. In the case where the protected circuit 6 is hooked up directly to the keypad 3 and to the interface circuit 10, the protected circuit 6 executes an instruction sequence stored in memory 35 so as to transmit the value of the code typed on the keypad 3 to the identification object 18. If the corresponding code is recognized by the identification support, the latter emits an identification signal on the interface circuit 10 destined for the protected circuit 6, thus performing an identification of the individual who typed in the code. In the man/machine interface, the keypad 3 can be replaced by means of biometric recognition; in this case, a biometric data item of the individual 17 is substituted for the code mentioned previously.

During a signature step 28, the individual 17 types a signature command on the keypad 3. The signature command is transmitted to the protected circuit 6 in the housing. On receipt of the signature command, if it has received the identification signal, the protected circuit 6 executes an enciphering operation which bears on the transactional data item displayed on the screen 4. The enciphering operation accesses the private signature key SK-DEV confined within the nonerasable memory part 36 of the protected circuit 6 inside the housing, thus irrefutably signing the data item displayed on the screen 4.

When one wishes to sign the data item displayed on the screen 4, correlatively with another transactional data item, the data are concatenated by the logic circuit 9 or directly by the protected circuit 6 before the enciphering operation.

The other transactional data item relates for example to the references of an account to be debited. These references are in the example of FIG. 3 procured by the physical identification object 18 which is a credit card.

During the signature step 28, it is advantageous to apply a one-way hash function before the enciphering operation. The hash function makes it possible to reduce the size of a data string to be enciphered and thus to accelerate the enciphering operation by means of the private key and a deciphering operation by means of the public key. The fact that the hash function is one-way makes it difficult for a third party to create another data string such that the application of the hash function to this other data string gives the same result as the hash function applied to the original data string.

In the example of FIG. 3, it is of interest to add a communication step 29. During the communication step 29, the result of the enciphering is sent in message form to the computer system by means of the connector 12 linked to the computer 19.

The identification step 27 can precede the presentation step 26, for example so as to allow the individual 17 to identify himself with a view to several successive transactions for each of which the presentation step 27 and the signature step 28 are thus repeated.

Hence, steps 26 to 28 assure the individual 17 that the apparatus 1 has signed the amount displayed on the screen 4, concatenating it for the particular case of a financial transaction with the number of the account to be debited. By deciphering the message sent in step 29, by means of the public key corresponding to the private key of the apparatus 1, the server 24 is assured that the message has indeed been sent by the apparatus 1 without the possibility of being corrupted by the computer system since the private signature key is confined within the protected circuit 6 inside the apparatus 1. The server 24 can thus debit the account referenced in the message by the amount transmitted in the message since the apparatus 1 authenticate that agreement has been given by means of the credit card 18 and of its confidential code. The server 25 has good reason to believe that the transaction between the individual 17 and the server 24 will not be repudiated since said transaction was carried out in a highly secure mode.

It is conceivable for the server 24 to ascertain the public key of the apparatus 1 by consulting a database which lists all the trustworthy apparatuses 1. A minimum of management is thus required in order to keep this database up to date. It is simpler and faster than the apparatus 1 transmitting its public key itself during step 29. This presents a danger if an element of the computer system attempts to simulate the apparatus 1 by creating a pair of private and public keys.

To avoid the abovementioned danger, the apparatus 1 sends the computer system a character string comprising a value of the public key which is the dual of his private signature key, by simultaneously sending a second signature, the so-called certification signature. To ensure that the apparatus 1 is a legitimate apparatus, the manufacturer applies a one-way hash function to the character string and enciphers the result of the hash function by means of a private key SK-FAB of the manufacturer. The result of the enciphering thus constitutes the certification signature that the manufacturer stores with the character string in the apparatus 1. Thus, the server 24 only needs to ascertain the public key of the manufacturer PK-FAB, common to numerous apparatuses 1. Specifically, when the apparatus 1 transmits the character string containing the public key PK-DEV of the apparatus as plaintext, with the certification signature to the computer system, it is sufficient for the server 24 to apply the one-way hash function to the character string containing the public key PK-DEV of the apparatus 1 and to decipher the certification signature by means of the public key PK-FAB of the manufacturer. If the result of the hash function is identical to the result of the deciphering, the server 24 is assured that the public key of the apparatus 1 is a legitimate public key and therefore that the apparatus 1 has been used irrefutably to sign all or some of the transactional data.

1. An apparatus (1) for performing transactions comprising a housing having protection against break-ins, in which are integrated:
an interface circuit (10) for receiving an identification support comprising an identification logic circuit;
man/machine interface means (3, 4) for presenting transactional data to a user and for gathering from the user identification data transmitted to the logic circuit of the support via the interface circuit (10) as well as signature commands relating to the transactional data presented;
a protected circuit (6) for delivering a first signature of the transactional data presented in response to the signature commands when the identification has been performed, said signature being obtained by enciphering a part at least of the transactional data by means of a private signature key stored in a nonerasable manner in said protected circuit.

2. The apparatus (1) for performing transactions as claimed in claim 1, characterized in that it comprises a means of communication (12) for exchanging data with a computer system.

3. The apparatus (1) for performing transactions as claimed in one of the preceding claims, characterized in that the protected circuit (6) contains a public key which is the dual of said private key, stored in a nonerasable manner.

4. The apparatus (1) for performing transactions as claimed in one of the preceding claims, characterized in that the protected circuit (6) contains an identification number for the apparatus, stored in a nonerasable manner.

5. The apparatus (1) for performing transactions as claimed in one of the preceding claims, characterized in that a memory (5, 35) contains a signature certifying an origin of the apparatus (1).

6. A method of manufacturing an apparatus (1) for performing transactions, characterized in that it comprises:
a burn step (15) during which a pair of dual cryptographic keys is secretly generated, consisting of a public key and of a private key of the apparatus, the private key being burned immediately into a protected circuit (6) in such a way as to not be able to leave any trace outside said protected circuit (6);
a mounting step (16) during which a man/machine interface (3, 4) is mounted on a housing, the protected circuit (6) and an interface circuit (10) are mounted in said housing and during which said housing is closed in such a way as to no longer be able to be opened or entered without leaving a visible trace of break-in.

7. The method of manufacturing an apparatus (1) for performing transactions as claimed in claim 6, characterized in that during the burn step (15), the public key is burned into the protected circuit (6).

8. The method of manufacturing an apparatus (1) for performing transactions as claimed in claim 6 or 7, characterized in that during the burn step (15), an identification number of the apparatus (1) is burned into the protected circuit (6).

9. The method of manufacturing an apparatus (1) for performing transactions as claimed in one of the preceding claims, characterized in that it comprises a certifying step during which a character string comprising at least the public key or the identification number, is enciphered by means of a private manufacturer key, in such a way as to obtain a signature certifying the origin of the apparatus (1) and in that this signature is stored in the apparatus.

10. A method for performing transactions by means of an apparatus (1) consisting of a housing which leaves a visible trace of any attempted break-in, said housing comprising man/machine interface means (3, 4) and an interface circuit (10) for interfacing with a physical identification object, characterized in that it comprises:
a presentation step during which at least one transactional data item is communicated to the apparatus (1) which displays it on the man/machine interface means (3, 4);
an identification step during which an identification support comprising an identification logic circuit is placed in contact with the interface circuit (10) and first identification data are gathered from the user by the man/machine interface means (3, 4), then transmitted to the identification logic circuit which delivers an identification signal if it recognizes said identification data;
a signature step during which, a signature command gathered on the man/machine interface means (3, 4) is transmitted in the housing to a protected circuit (6) which, if said identification data are recognized by the identification circuit, signs a part at least of the transactional data by means of a private signature key stored in a nonerasable manner in said protected circuit (6).

11. The method for performing transactions by means of an apparatus (1) as claimed in claim 10, characterized in that during the signature step, said part at least of the transactional data is concatenated with a second identification data item procured by the identification circuit in such a way that the signature by means of the private signature key bears on the result of the concatenation.

12. The method for performing transactions by means of an apparatus (1) as claimed in one of claims 10 or 11, characterized in that it comprises a communication step during which the signature is sent by the apparatus (1) to a computer system.

13. The method for performing transactions by means of an apparatus (1) as claimed in claim 12, characterized in that during the communication step, the apparatus (1) sends the computing system a character string comprising at least one value of public key which is the dual of the private signature key, accompanied by a certification signature for certifying said character string.
